(19) United States
(12) Patent Application Publication
(10) Pub. No.: US 2014/0320228 A1
(43) Pub. Date: Oct. 30, 2014

(54) NON-RECIPROCAL CIRCUIT ELEMENT, COMMUNICATION APPARATUS EQUIPPED WITH CIRCUIT INCLUDING NON-RECIPROCAL CIRCUIT ELEMENT, AND MANUFACTURING METHOD OF NON-RECIPROCAL CIRCUIT ELEMENT

(71) Applicants: NEC Corporation, (US); Nec Corporation, Minato-ku, Tokyo (JP)

(72) Inventor: Naoyuki Orihashi, Tokyo (JP)

(73) Assignee: NEC CORPORATION, Tokyo (JP)

(21) Appl. No.: 14/365,572

(22) PCT Filed: Oct. 12, 2012
(86) PCT No.: PCT/JP2012/006570

§ 371 Date: Jun. 13, 2014

(30) Foreign Application Priority Data
Dec. 15, 2011 (JP) 2011-274626

(51) Int. Cl. H01P 1/38

(52) U.S. Cl. CPC H01P 1/38
USPC 333/1.1; 29/602.1

(57) ABSTRACT

A circulator includes a ferrite disposed above a PCB, a metal cover that covers above the ferrite and is formed integrally, a plurality of connection parts that electrically connect the metal cover to a plurality of respective signal transmission lines above the PCB, and a permanent magnet that applies a magnetic field to the ferrite. Thus, it is possible to provide, for example, a non-reciprocal circuit element that is composed of a small number of parts and can be easily mounted on a circuit board, a communication apparatus equipped with a circuit including the non-reciprocal circuit element, and a manufacturing method of a non-reciprocal circuit element.

### TECHNICAL FIELD

The present invention relates to a non-reciprocal circuit element that is composed of a small number of parts and can be easily mounted on a circuit board, a communication apparatus equipped with a circuit including the non-reciprocal circuit element, and a manufacturing method of a non-reciprocal circuit element.

### BACKGROUND ART

Simplifying a circulator or an isolator, which are non-reciprocal circuit elements, is a major issue in a high-frequency circuit. As the circulators, there are waveguide and SMT (Surface Mount Technology) circulators.

The waveguide circulator is a circulator that includes a ferrite disposed inside a waveguide. In such a structure of the circulator, as a high frequency signal is locked inside the waveguide, there is no need to consider an influence of a radiation loss.

The SMT circulator is a circulator in which the SMT circulator is configured above transmission lines formed on a dielectric board. As the SMT circulator uses transmission lines, the SMT circulator is far smaller than the waveguide circulator. When a dielectric board is formed of a material the same as that of a PCB (Printed Circuit Board), a circulator can be integrated inside the PCB. Accordingly, the SMT circulator is characterized in that the SMT circulator is small in size and has high mountability.

Meanwhile, there is a problem in the SMT circulator that an insertion loss tends to be greater than in the waveguide circulator. As the SMT circulator uses the transmission lines, when an electromagnetic field generated by a high frequency signal that is input through the transmission line cannot be locked inside the circulator, a radiation loss is generated, thereby increasing an insertion loss.

Patent Literature 1 discloses a structure to prevent such a radiation loss. FIG. 19 is a perspective diagram showing a circulator disclosed in Patent Literature 1. The circulator shown in FIG. 19 includes an outer conductor 101, a ferrimagnet 102, an inner conductor 103, a ferrimagnet 104, and an outer conductor 105. The inner conductor 103 includes a center conductor part 106 and a transmission line conductor part 107. In order to suppress a radiation loss, the ferrimagnets 102 and 104 and the inner conductor 103 are covered by the outer conductors 101 and 105. The ferrimagnet 102 is inserted between the outer conductor 101 and the inner conductor 103, while the ferrimagnet 104 is inserted between the inner conductor 103 and the outer conductor 105. In the circulator shown in FIG. 19, a DC magnetic field H is applied from bottom to top.

### CITATION LIST

### Patent Literature

Patent Literature 1: Japanese Unexamined Patent Application Publication No. S62-82802

### SUMMARY OF INVENTION

### Technical Problem

The above-mentioned waveguide circulator and the SMT circulator disclosed in Patent Literature 1 have the following problems.

As the waveguide circulator has a three-dimensional structure, it is difficult to miniaturize the waveguide circulator. Further, most circuit parts in a high frequency circuit are mounted on a PCB, and when a transmission line above the PCB transfers a high frequency signal to a waveguide, it is necessary to convert the signal. That is, the waveguide circulator requires a circuit for signal conversion. It is thus difficult to simplify or miniaturize the structure of the waveguide circulator.

It is necessary to prevent a radiation loss in the SMT circulator. Therefore, as shown in FIG. 19, in addition to the inner conductor 103, the ferrimagnets 102 and 104 that input and output signals and the outer conductors 101 and 105 that cover the ferrimagnets must be mounted. As explained above, there is a problem in the SMT circulator that the SMT circulator requires a great number of parts, and it is difficult to simplify the structure of the SMT circulator.

The present invention is made to solve such a problem and an aim of the present invention is to provide a non-reciprocal circuit element that is composed of a small number of parts and can be easily mounted on a circuit board, a communication apparatus equipped with a circuit including the non-reciprocal circuit element, and a manufacturing method of a non-reciprocal circuit element.

### Solution to Problem

A non-reciprocal circuit element according to the present invention includes: a ferrimagnet that is disposed above a circuit board; a conductive cover that covers an upper surface of the ferrimagnet and is formed integrally; a plurality of connection parts that electrically connect the conductive cover to a plurality of respective signal transmission lines above the circuit board; and a magnet that applies a magnetic field to the ferrimagnet.

A method of manufacturing a non-reciprocal circuit element according to the present invention includes: disposing a ferrimagnet and a conductive cover above a circuit board, in which the conductive cover covers an upper surface of the ferrimagnet, is electrically connected to each of a plurality of signal transmission lines above the circuit board, and is integrally formed; and disposing a magnet at a position that applies a magnetic field to the ferrimagnet.

### Advantageous Effects of Invention

According to the present invention, it is possible to provide a non-reciprocal circuit element that is composed of a small number of parts and can be easily mounted on a circuit board, a communication apparatus equipped with a circuit including the non-reciprocal circuit element, and a non-reciprocal circuit element.

### BRIEF DESCRIPTION OF DRAWINGS

FIG. 1 is a cross-sectional diagram showing a configuration example of a circulator according to a first exemplary embodiment;

FIG. 2 is a perspective diagram showing a configuration example of the circulator according to the first exemplary embodiment;

FIG. 3 is a top view showing a configuration example of the circulator according to the first exemplary embodiment;

FIG. 4 is a graph showing an example of insertion loss characteristics of the circulator according to the first exemplary embodiment;

FIG. 5 is a graph showing an example of isolation characteristics of the circulator according to the first exemplary embodiment;

FIG. 6 is a cross-sectional diagram showing another variation of the circulator according to the first exemplary embodiment;

FIG. 7 is a cross-sectional diagram showing a first circulator according to a second exemplary embodiment;

FIG. 8 is a cross-sectional diagram showing a second circulator according to the second exemplary embodiment;

FIG. 9 is a cross-sectional diagram showing a first circulator according to a third exemplary embodiment;

FIG. 10 is a cross-sectional diagram showing a second circulator according to the third exemplary embodiment;

FIG. 11 is a cross-sectional diagram showing a third circulator according to the third exemplary embodiment;

FIG. 12 is a cross-sectional diagram showing a fourth circulator according to the third exemplary embodiment;

FIG. 13 is a cross-sectional diagram showing a fifth circulator according to the third exemplary embodiment;

FIG. 14 is a cross-sectional diagram showing a sixth circulator according to the third exemplary embodiment;

FIG. 15 is a cross-sectional diagram showing a configuration example of a circulator according to a fourth exemplary embodiment;

FIG. 16 is a cross-sectional diagram showing a configuration example of a circulator according to a fifth exemplary embodiment;

FIG. 17 is a top view showing a configuration example of a circulator according to a sixth exemplary embodiment;

FIG. 18 is a cross-sectional diagram showing a configuration example of the circulator according to the sixth exemplary embodiment; and

FIG. 19 is a perspective diagram of a circulator according to a related art.

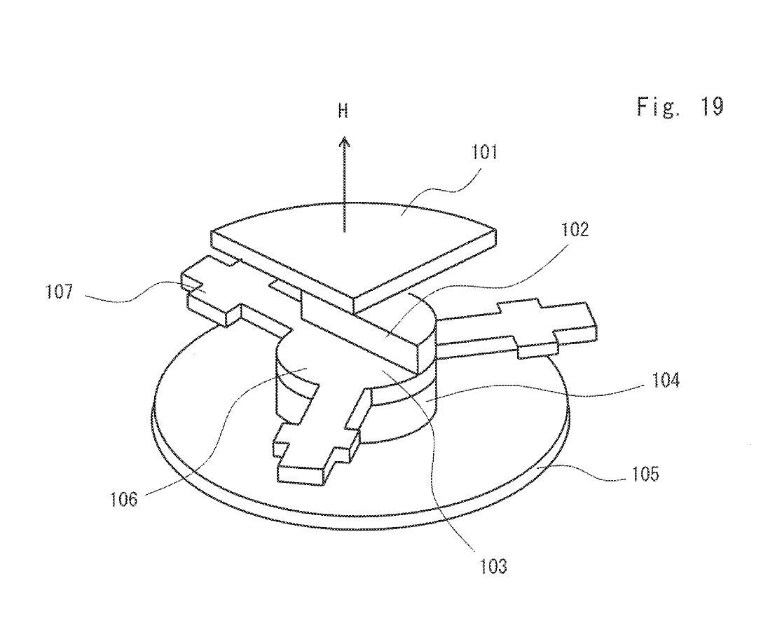

### DESCRIPTION OF EMBODIMENTS

### First Exemplary Embodiment

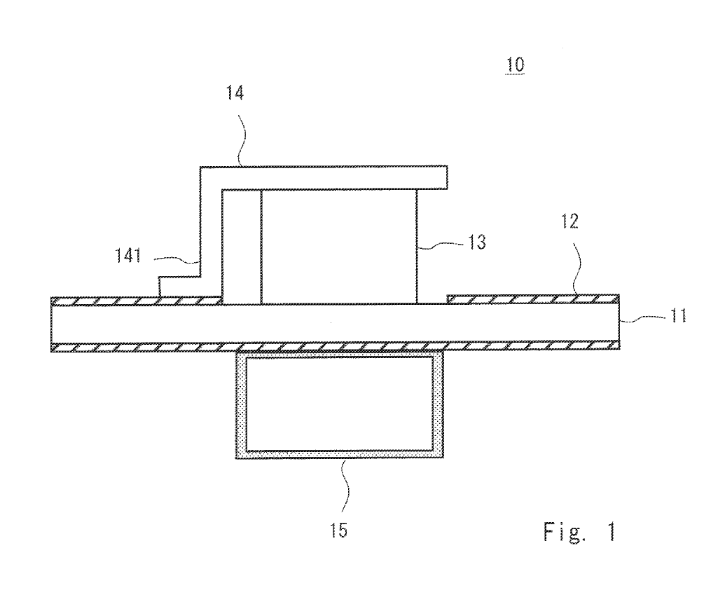

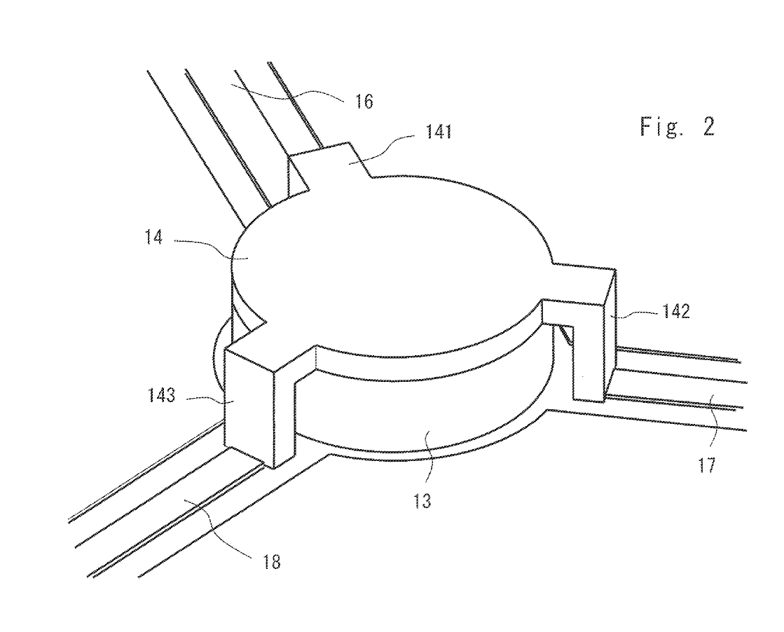

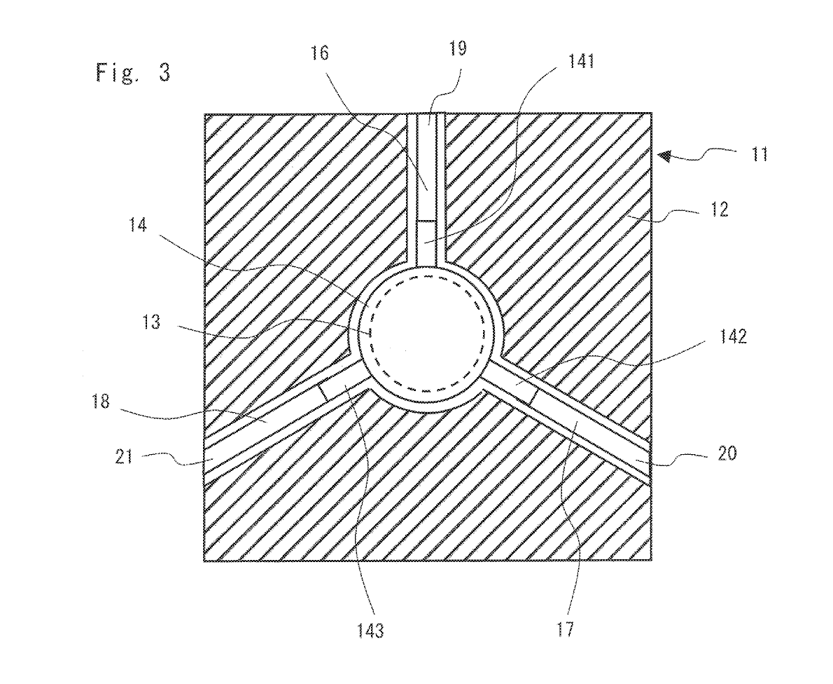

Hereinafter, a first exemplary embodiment of the present invention shall be explained with reference to the drawings. FIG. 1 is a cross-sectional diagram showing a configuration example of a circulator according to this exemplary embodiment, FIG. 2 is a perspective diagram of the circulator, and FIG. 3 is a top view thereof. A circulator 10 is disposed above a PCB 11. A pattern 12 is formed on the surface of the PCB 11. The circulator 10 is a three-port SMT circulator including a ferrite 13, a metal cover 14, connection parts 141 to 143, and a permanent magnet 15.

In the circulator 10, the ferrite 13 is disposed above the PCB 11. A top surface of the ferrite 13 is covered by the metal cover 14. The connection parts 141, 142, and 143 that are connected to the metal cover 14 electrically connect the metal cover 14 to transmission lines 16, 17 and 18, respectively, which are above the PCB 11 and explained later. The permanent magnet 15 is disposed on a surface opposite to the surface of the PCB 11 where the ferrite 13 is mounted. This permanent magnet 15 applies a magnetic field to the ferrite 13. With such a configuration, as a conductor part for transferring a high frequency signal in the circulator 10 is formed by the metal cover 14, the number of necessary parts in the circulator 10 can be reduced. Moreover, the circulator 10 can be easily mounted on the PCB 11.

Hereinafter, each part of the circulator 10 shall be explained in detail. The PCB 11 is a dielectric circuit board on which the circulator 10 is mounted and is composed of multiple laminated layers of a dielectric layer and a metal layer. Note that the circuit board on which the circulator 10 is mounted is not limited to a PCB and may be a circuit board having other configurations.

The pattern 12 is a conductive pattern formed on an upper surface and a lower surface of the PCB 11. The pattern 12 includes signal lines and a ground pattern, which form the transmission lines of signals. The pattern 12 is not formed at a central part of the upper surface of the PCB 11 (i.e., not formed at a part where the ferrite 13 is mounted). In the central part of the upper surface of the PCB 11, the pattern is discontinued (punched pattern).

The ferrite 13 has a cylindrical shape and is disposed in the central part (in the punched pattern) of the upper surface of the PCB 11. The ferrite 13 is sandwiched between the PCB 11 and the metal cover 14. The ferrite 13 is a ferrimagnet having ferrimagnetism and is a material such as YIG (Yttrium Iron Garnet), barium ferrite, or strontium ferrite. Note that the material disposed in the central part of the upper surface of the PCB 11 is not limited to a ferrite as long as it is a ferrimagnet having ferrimagnetism and generating a gyromagnetic effect that is explained later. Further, the shape of the ferrite 13 is not necessarily cylindrical but may instead be a polygonal column etc.

The metal cover 14 is a conductive cover that is formed of (integrated with) a circular metal plate. Note that the metal cover 14 covers the upper surface (principal surface) of the ferrite 13. Generally, as a ferrite is a dielectric body having a high dielectric constant with a dielectric constant exceeding ten, high frequency electric fields are concentrated more on the lower surface (ferrite layer) than on the upper surface (air layer). It is thus possible to reduce electromagnetic waves emitted from the upper surface. Note that instead of the metal cover 14, a conductive cover formed of a conductive material may cover the upper surface of the ferrite 13. The metal cover 14 may not be formed of a circular metal plate as long as it is formed integrally.

In FIGS. 1 to 3, the metal cover 14 covers an entire upper surface of the ferrite 13. However, in this exemplary embodiment, even when the metal cover 14 covers only a part of the upper surface of the ferrite 13 and most parts of the upper surface of the ferrite 13 are exposed, such a state could be included in the state where “the upper surface of the ferrite 13 is covered”. With the structure according to this exemplary embodiment where the electric field intensity of the lower surface is greater than that of the upper surface, it is possible to reduce the radiation loss. Therefore, there is no limitation on the shape of the metal cover 14 as long as the metal cover 14 can achieve characteristic impedance matching between the transmission lines and the ferrite 13 above the PCB 11.

The metal cover 14 is fixed on the PCB 11 by the three connection parts 141, 142, and 143. The three connection parts 141, 142, and 143 are electrically connected to the transmission lines 16, 17, and 18 of the pattern 12, respectively. With such a configuration, the metal cover 14 transfers a high frequency signal input via the connection part and outputs it to a different connection part.

Note that in FIG. 1, as for the positional relationship between the PCB 11, the ferrite 13, and the metal cover 14, the upper surface of the PCB 11, the upper surface of the ferrite 13, and the metal cover 14 are positioned substantially in parallel to one another. However, when a magnetic field generated between the metal cover 14 and the PCB 11 is orthogonal to an external DC magnetic field applied by the permanent magnetic 15, the positional relationship between the PCB 11, the ferrite 13, and the metal cover 14 is not limited to the one mentioned above.

The connection parts 141 to 143 are formed of the material the same as that of the metal cover 14 and are integrally formed with the metal cover 14. The connection parts 141, 142, and 143 electrically connect the metal cover 14 to the transmission lines 16, 17, and 18 that are formed in the pattern 12 on the PCB 11, respectively. Further, the connection parts 141 to 143 are fixed on the PCB 11 and support the metal cover 14. Note that in FIG. 1, only one connection part 141 is shown and the connection parts 142 and 143 are not shown.

As for the connection parts 141 to 143, one ends are at an outer edge part of the metal cover 14, and other ends are fixed on the PCB 11. The connection parts 141 to 143 protrude from a side surface of the metal cover 14 and bend halfway toward a vertical direction (downward in FIG. 2), so that the other ends are positioned on the PCB 11. As for the metal cover 14, a central angle made by the connection parts 141 and 142 is substantially 120°. Similarly, a central angle made by the connection parts 142 and 143 and a central angle made by the connection parts 143 and 141 are also substantially 120°. In FIGS. 1 and 2, although there are gaps between the parts of the connection parts 141 to 143 that bend toward the vertical direction and the ferrite 13, the gaps are not necessarily. The bends of the parts are not necessarily one step and may instead be bent in several steps. An angle of the bend is not necessarily vertical. Finally, the connection parts 141, 142, and 143 should only be electrically connected to the transmission lines 16, 17, 18 above the PCB 11.

The permanent magnet 15 is disposed on the lower surface of the PCB 11 (a second plane that is opposite to a first plane where the ferrite 13 is disposed). In FIG. 1, the permanent magnet 15 is disposed at a position opposite to the ferrite 13 and applies a magnetic field to the ferrite 13. Specifically, inside the ferrite 13, a DC magnetic field is generated by the permanent magnet 15 from top to bottom or from bottom to down in FIG. 1 or 2. In FIG. 3, a DC magnetic field is generated by the permanent magnet 15 in a direction from the front side to the back side of the drawing or from the back side to the front side of the drawing. The direction of the DC magnetic field is a direction vertical to the high frequency magnetic field inside the ferrite 13 that is generated when a high frequency signal passes through the metal cover 14. Note that in FIG. 1, although an area of the principle surface of the permanent magnet 15 is greater than an area of the upper surface of the ferrite 13, it is not limited to this.

Note that the permanent magnet 15 may be disposed at a position other than the lower surface of the PCB 11 as long as the permanent magnet 15 can generate a DC magnetic field in a direction vertical to the high frequency magnetic field inside the ferrite 13 that is generated when a high frequency signal passes through the metal cover 14. For example, the permanent magnet 15 may be disposed on a surface the same as the surface of the PCB 11 where the ferrite 13 is mounted. Further, the number of the permanent magnets 15 is not limited to one. For example, a plurality of permanent magnets may be disposed in series above and below the ferrite 13. Further, the magnet disposed in the circulator 10 for applying a magnetic field to the ferrite 13 is not necessarily a permanent magnet.

The transmission lines 16, 17, and 18 are lines for transmitting a high frequency signal. The transmission lines 16, 17, and 18 include power supply points 19, 20, and 21, respectively, which are input ends of the circulator 10 for a high frequency signal from outside.

Hereinafter, an operation of the circulator 10 shall be explained. For the circulator 10, a high frequency signal is supplied from the power supply point 19 to the metal cover 14 via the transmission line 16 and the connection part 141. The high frequency signal supplied to the metal cover 14 generates a high frequency electromagnetic field between the metal cover 14 and the PCB 11 (inside the ferrite 13). Specifically, an electric field is generated in a direction vertical to the surface of the PCB 11 (a height direction of the ferrite 13 in FIG. 1), and a magnetic field is generated in a direction parallel to the surface of the PCB 11.

Inside the ferrite 13, a DC magnetic field is applied by the permanent magnet 15 in the height direction of the ferrite 13 (a normal direction of the upper surface of the ferrite). The direction of the DC magnetic field is a direction vertical to the high frequency magnetic field generated inside the ferrite 13 by the high frequency signal. As a gyromagnetic effect is generated inside the ferrite 13 by the DC magnetic field and the high frequency magnetic field, the high frequency signal rotates on the planar surface of the PCB inside the ferrite 13. When the DC magnetic field is applied from bottom to top of FIG. 3, the high frequency signal is output to the transmission line 17 via the connection part 142. When the DC magnetic field is applied from top to bottom of FIGS. 2 and 3, the high frequency signal is output to the transmission line 18 via the connection part 143. In this way, the high frequency signal is output only in one direction.

When the high frequency signal is supplied from the power supply point 20 to the metal cover 14 via the transmission line 17 and the connection part 142 or when the high frequency signal is supplied from the power supply point 21 to the metal cover 14 via the transmission line 18 and the connection part 143, the high frequency signal is output only in one direction in accordance with a principle similar to that of the case explained above.

The above-mentioned exemplary advantage of the circulator 10 has been confirmed through a simulation. In this simulation, a North pole and a South pole of the permanent magnet 15 are disposed in such a way that the DC magnetic field is applied from bottom to top in FIGS. 1 and 3 (in FIG. 23, in a direction from the back side to front side of the drawing). At this time, passing characteristics to the power supply point 20 when the high frequency signal is supplied from the power supply point 19 have been analyzed.

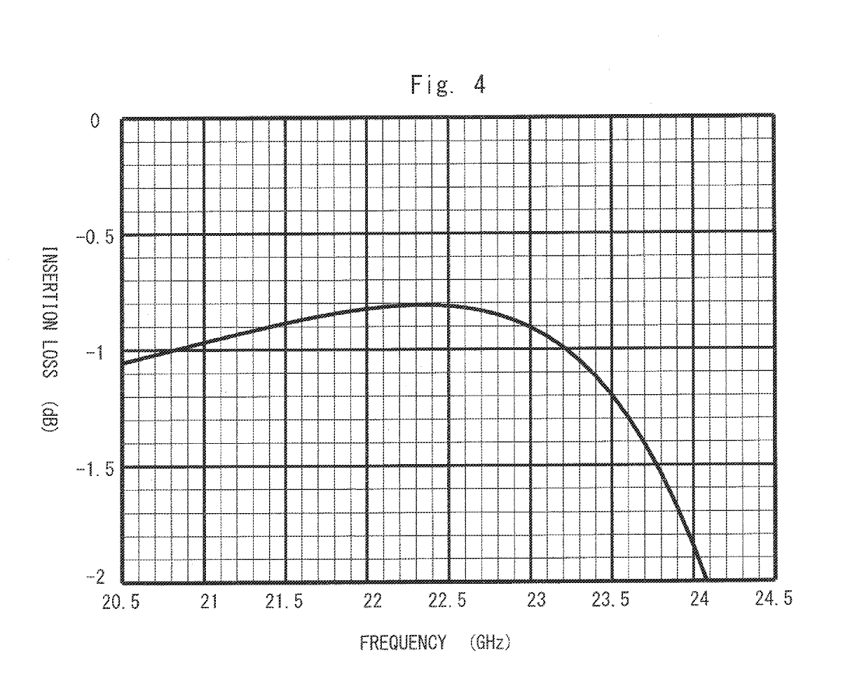

FIG. 4 shows insertion loss characteristics of the high frequency signal from the power supply point 19 to the power supply point 20. In FIG. 4, an insertion loss around a central part of the frequency band 22.5 GHz is about 0.8 dB.

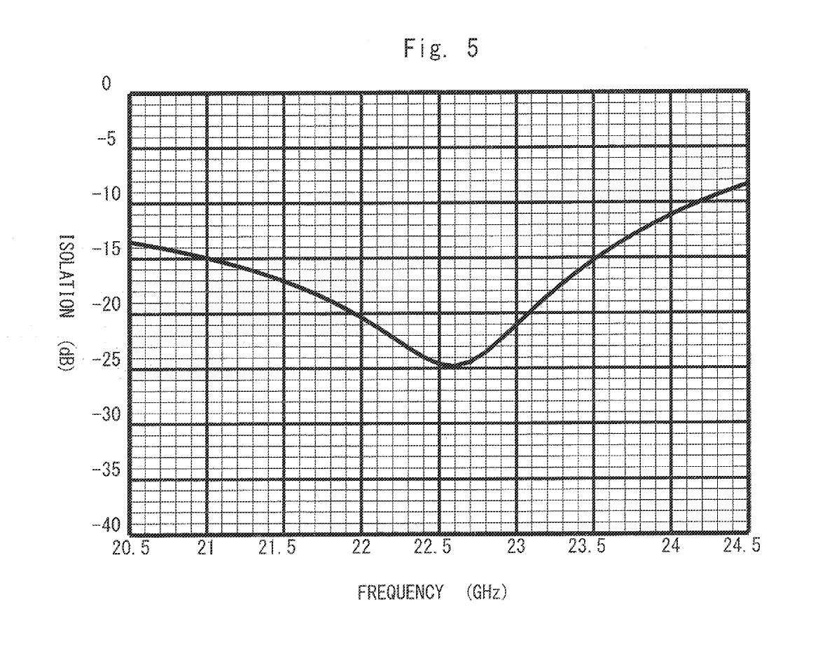

FIG. 5 shows a result of isolation characteristics indicating a degree of a high frequency signal leaking from the power supply point 19 to the power supply point 21. In the frequency band around the central part of the frequency band 22.5 GHz, isolation of about 25 dB has been obtained. As described above, it can be seen from FIGS. 4 and 5 that, in the circulator 10 according to the first exemplary embodiment, characteristics necessary for the circulator have been obtained.

The circulator 10 according to the first exemplary embodiment functions also as a conductor part that transfers the high frequency signal. Therefore, the circulator 10 has a simple structure in which the ferrite 13 and the metal cover 14 are mounted above the upper surface of the PCB 11. That is, the circulator 10 is composed of a small number of parts and can be easily mounted on the PCB 11.

Further, in the circulator 10 shown in FIGS. 1 to 3, the metal cover 14 and the connection parts 141 to 143 are formed integrally. It is thus easy to mount the circulator 10 on the PCB 11. As the connection parts 141 to 143 are fixed on the PCB 11, which is formed of a metal material the same as the material of the metal cover 14, it is possible to support the metal cover 14 stably. Moreover, there is an exemplary advantage that the three legs of the connection parts 141 to 143 that bend in the vertical direction can hold the position of the ferrite 13. The three legs play a role as a guide for inserting the ferrite, thereby determining the position of the ferrite 13. The holding the position of the ferrite 13 has the effect of preventing the ferrite 13 from dropping or from being displaced. Accordingly, the circulator 10 has an exemplary advantage of reducing characteristic deterioration such as deterioration of isolation and reflective characteristics.

The permanent magnet 15 is disposed on the lower surface of the PCB 11. Thus, in comparison to the case in which the permanent magnet 15 is disposed on the upper surface of the PCB 11, there is a larger area on the upper surface of the PCB 11 where elements can be mounted.

The metal cover 14 that covers the upper surface of the ferrite 13 is formed integrally. Therefore, as compared to the circulator configured in such a way that a plurality of conductors are disposed on the upper surface of the ferrite 13, in the circulator 10 according to the first exemplary embodiment, the number of necessary parts can be reduced. Moreover, in the circulator 10 according to the first exemplary embodiment, it is easier to attach the metal cover 14 on the upper surface of the ferrite 13.

As the metal cover 14 covers the upper surface of the ferrite 13, it is possible to reduce the radiation loss. Since the dielectric board of the ferrite 13 and the PCB 11 is mounted on the lower surface of the metal cover 14, the effective dielectric constant of the lower surface is greater than that of the upper surface on which there is only the air layer. As the effective dielectric constant of the lower surface is high, the high frequency electric fields generated in the metal cover 14 are concentrated on the lower surface side. It is thus possible to reduce the amount of radiation of electric fields into the air layer, thereby reducing the radiation loss. Meanwhile, as for the transmission lines above the PCB 11, since there is a dielectric body on the lower surface, the high frequency electric fields are concentrated on the lower surface. That is, since a difference between the electric field distribution of the PCB side and that of the ferrite side is small, it is easy to realize impedance matching and to connect the PCB 11 to the ferrite 13. Accordingly, it is possible to realize an SMT circulator with a small insertion loss as a whole.

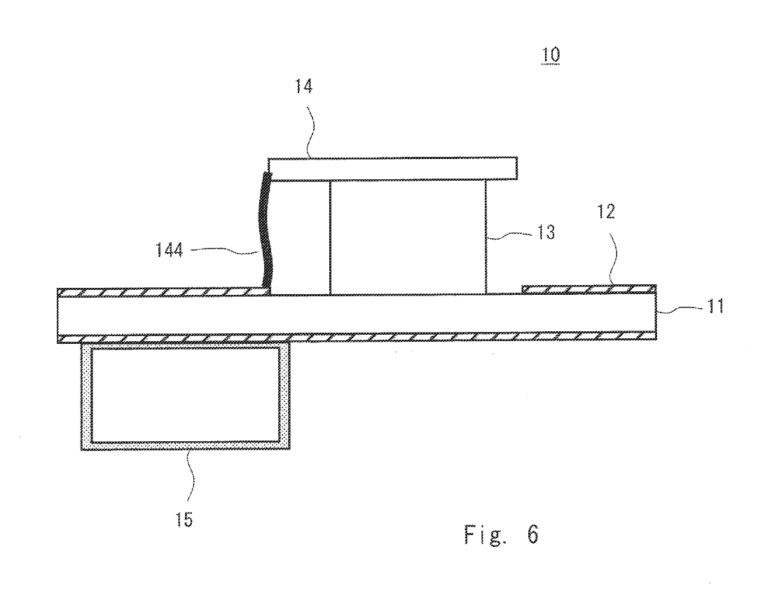

Note that the configuration or the arrangement of the connection parts 141 to 143 and the permanent magnet 15 in the circulator 10 is not limited to the examples shown in FIGS. 1 to 3. FIG. 6 is a cross-sectional diagram showing a variation of another circulator.

A circulator 10 shown in FIG. 6 includes conductive lines 144 to 146 in place of the connection parts 141 to 143 shown in FIGS. 1 to 3. Note that in FIG. 6, the conductive lines 145 and 146 are not shown. In a similar manner to that of the connection parts 141 to 143, the conductive lines 144 to 146 electrically connect the transmission lines 16 to 18 above the PCB 11 to the metal cover 14. The conductive lines 144 to 146 are not formed integrally with the metal cover 14 and fixed to the outer edge part of the metal cover 14 at the time of mounting the circulator 10.

The permanent magnet 15 generates a DC magnetic field in the height direction of the ferrite 13 (a direction vertical to the magnetic field generated inside the ferrite 13 by the high frequency signal). Although the permanent magnet 15 is disposed on the lower surface of the PCB 11, the permanent magnet 15 is not disposed at a position that is opposite to the ferrite 13. As another configuration of the circulator 10 shown in FIG. 6 is the same as that of the circulator 10 shown in FIGS. 1 to 3, an explanation of the circulator 10 shown in FIG. 6 shall be omitted.

Also in the circulator 10 shown in FIG. 6, the metal cover 14 not only reduces the electromagnetic waves emitted from the upper surface of the ferrite 13 but also functions as a conductor part that transfers a high frequency signal in the circulator 10. Therefore, the circulator 10 shown in FIG. 6 is composed of a small number of parts and thus can be easily mounted on the PCB 11.

However, in order for the permanent magnet 15 to apply a stronger magnetic field to the ferrite 13, it is preferable to dispose the permanent magnet 15 at a position opposite to the ferrite 13 (this is because the distance between the ferrite 13 and the permanent magnet 15 will become shorter).

### Second Exemplary Embodiment

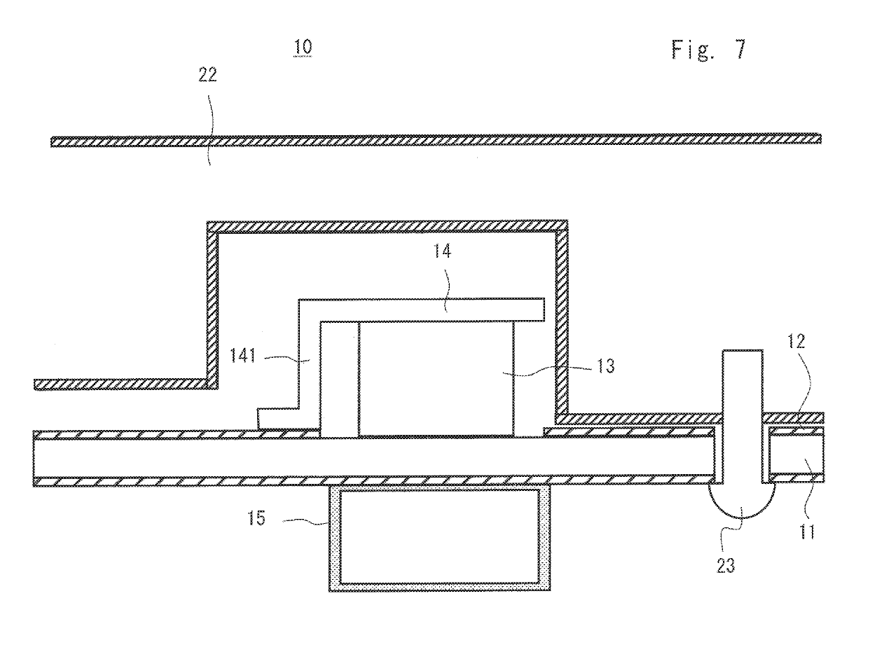

Next, a circulator according to a second exemplary embodiment of the present invention shall be explained. FIG. 7 is a cross-sectional diagram of a first circulator 10 according to the second exemplary embodiment. The circulator 10 further includes a metal housing 22 in addition to the configuration shown in FIG. 1. The metal housing 22 is formed of a metal material that functions as an electromagnetic shield such as aluminum alloy and is fixed on the upper surface of the PCB 11 by a screw 23. In the metal housing 22, a cavity structure is formed in the upper surface of the metal cover 14. The metal housing 22 covers, by the cavity structure, the upper surfaces of the ferrite 13, the metal cover 14, and the connection parts 141 to 143, and circumferences of the metal cover 14 and the connection parts 141 to 143. As the metal housing 22 can reduce the electromagnetic radiation from an end surface of the ferrite 13, it is possible to further reduce the insertion loss of the circulator 10.

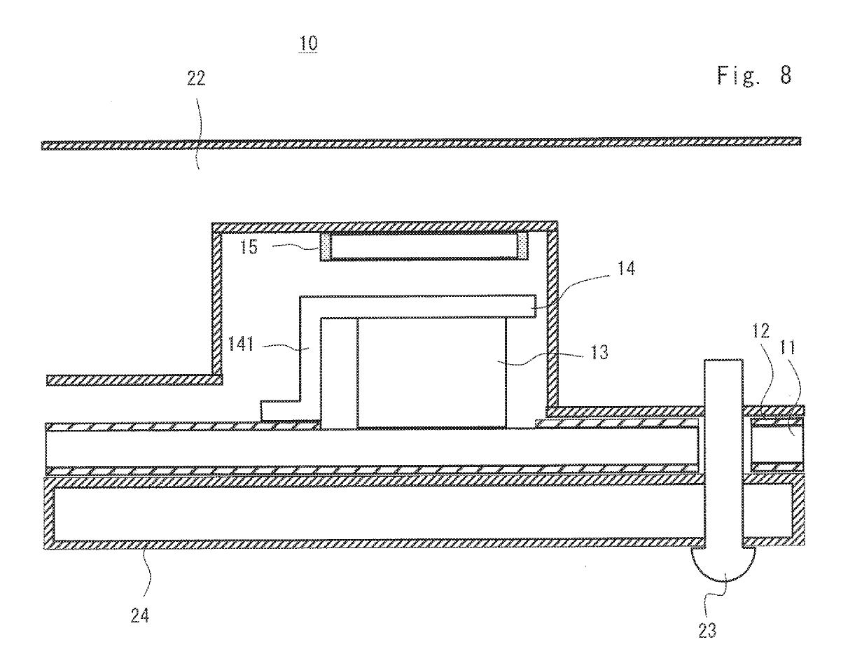

FIG. 8 shows a second circulator 10 according to the second exemplary embodiment. In FIG. 8, the circulator 10 further includes a metal housing 24 in addition to the configuration shown in FIG. 7. The metal housing 24 is fixed on the lower surface of the PCB 11 by the screw 23. The metal housing 24 covers at least the parts that are opposite to the ferrite 13 and the metal cover 14 at the lower surface of the PCB 11. The permanent magnet 15 is attached to a metal wall of the metal housing 22 (inside the above-mentioned cavity structure) that is opposite to the metal cover 14. However, the permanent magnet 15 may be disposed at any place as long as an appropriate magnetic field is applied to the ferrite 13. The permanent magnet 15 may be disposed, for example, outside the cavity, not only inside the cavity. However, in order for the permanent magnet 15 to apply a greater magnetic field to the ferrite 13, it is more desirable to dispose the permanent magnet 15 inside the cavity structure and at a position opposite to the ferrite 13. With the above-mentioned configuration, the circulator 10 shown in FIG. 8 can achieve an exemplary advantage of reducing characteristic deterioration such as deterioration of isolation and deterioration of reflective characteristics due to a change in the shape, and age-related deterioration of elements. This is because by further including the metal housing 24 in addition to the configuration of the circulator 10 shown in FIG. 7, the PCB is supported by the lower surface. The shape of the PCB is thus maintained, thereby reducing deterioration of characteristics caused by a fluctuation in the shape of the PCB.

Note that the metal housing 22 or 24 may be formed of a material other than the metal material as long as it functions as an electromagnetic shield. For example, in a plastic housing having a cavity structure, when a film having a function of an electromagnetic shield is stuck inside the cavity structure, the housing can reduce the electromagnetic radiation from the end surface of the ferrite 13. The metal housing 24 may be formed of a material with no electromagnetic shielding effect as long as the electromagnetic waves to the lower surface can be shielded by the metal pattern of the PCB 11.

### Third Exemplary Embodiment

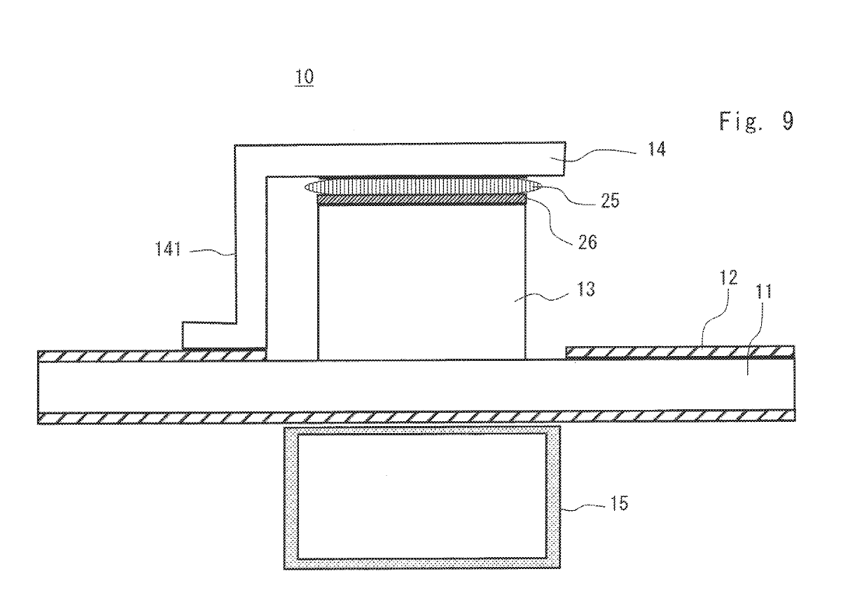

A first circulator according to a third exemplary embodiment of the present invention shall be explained. FIG. 9 is a cross-sectional diagram showing the first circulator 10 according to the third exemplary embodiment. A difference from the structure shown in FIG. 1 is that in the circulator 10 shown in FIG. 9, the ferrite 13 and the metal cover 14 are fixed by a conductive adhesive 25. A conductive member 26 for better adherence of the adhesive 25 is fixed on the upper surface of the ferrite 13. The adhesive 25 bonds the conductive member 26 with the metal cover 14, thereby fixing the ferrite 13 to the metal cover 14. In this manner, the gap between the ferrite 13 and the metal cover 14 is eliminated, thus making it possible to reduce characteristic deterioration such as deterioration of isolation and reflective characteristics of the circulator 10 that is generated due to the gap. The conductive member 26 may be a metal pattern that is patterned directly on the ferrite 13 or may be other conductive materials. The conductive member 26 is not necessarily required as long as the ferrite 13 is fixed to the metal cover 14.

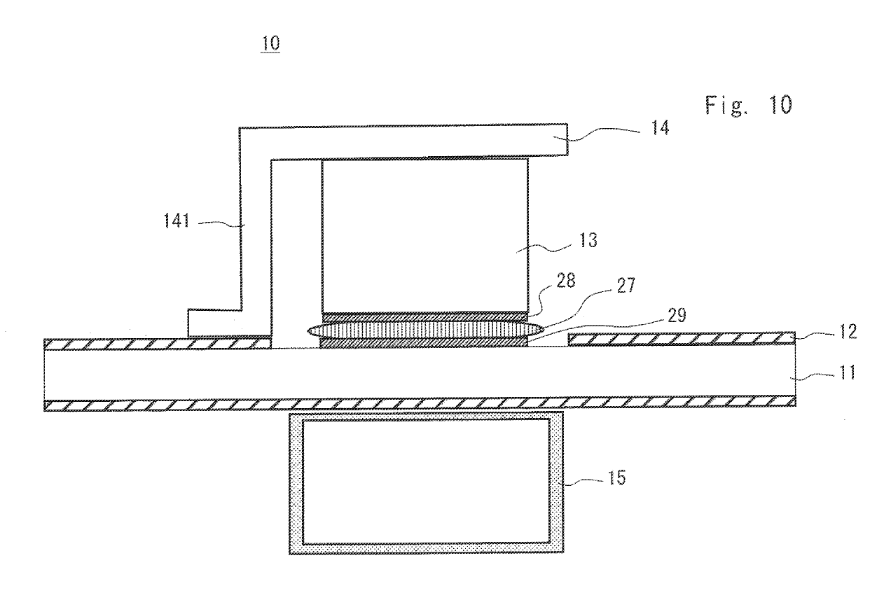

A second circulator according to the third exemplary embodiment of the present invention shall be explained. FIG. 10 is a cross-sectional diagram showing the second circulator 10 according to the third exemplary embodiment. A difference from the structure shown in FIG. 1 is that in the circulator 10 shown in FIG. 10, the ferrite 13 and the PCB 11 are fixed by a conductive adhesive 27. Conductive members 28 and 29 for better adherence of the adhesive 27 are fixed on the lower surface of the ferrite 13 and the upper surface of the PCB 11, respectively. The adhesive 27 bonds the conductive member 28 with the conductive member 29, fixing the ferrite 13 fix to the PCB 11. In this manner, the gap between the ferrite 13 and PCB 11 is eliminated, thus making it possible to reduce characteristic deterioration such as deterioration of isolation and reflective characteristics of the circulator 10 that is generated due to the gap. The conductive members 28 and 29 may be metal patterns that are patterned directly on the ferrite 13 or may be other conductive materials. The conductive members 28 and 29 are not necessarily required as long as the ferrite 13 is adhered to the PCB 11.

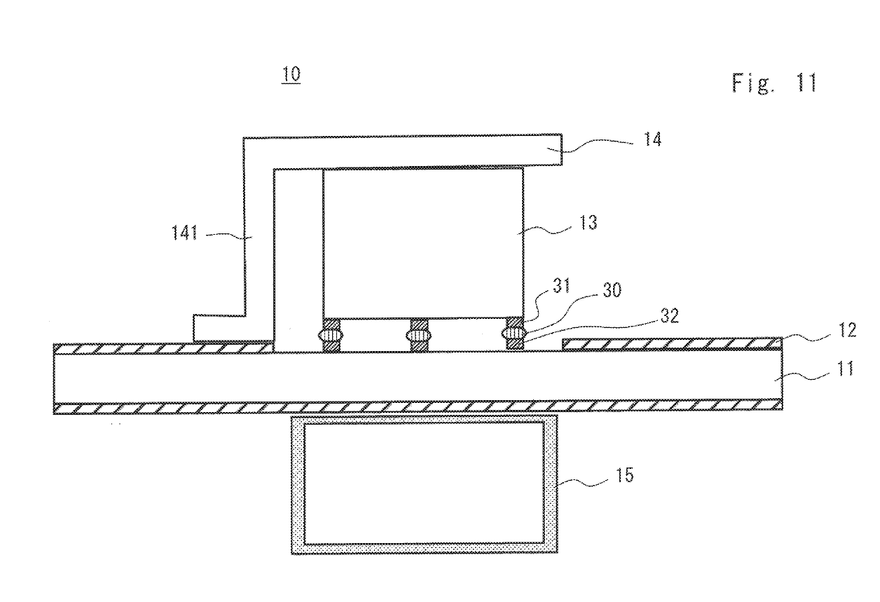

A third circulator according to the third exemplary embodiment of the present invention shall be explained. FIG. 11 is a cross-sectional diagram of the third circulator 10 according to the third exemplary embodiment. A difference from the structure shown in FIG. 1 is that in the circulator 10 shown in FIG. 11, an outer circumference part and a central part of the ferrite 13 and the PCB 11, respectively, are fixed by a conductive adhesive 30. The conductive members 31 and 32 for better adherence of the adhesive 30 are fixed on the lower surface of the ferrite 13 and the upper surface of the PCB 11, respectively. The conductive members 31 and 32 are disposed in the outer circumference part and at a center of the lower surface of the ferrite 13. The adhesive 30 bonds the conductive member 31 with the conductive member 32, thereby fixing the ferrite 13 to the PCB 11. In this manner, as the gap between the ferrite 13 and the PCB 11 is fixed, it is possible to reduce characteristic deterioration of the circulator 10 generated due to the gap. The conductive members 31 and 32 may be metal patterns that are patterned directly on the ferrite 13 or may be other conductive materials. The conductive members 31 and 32 are not necessarily required as long as the ferrite 13 is adhered to the metal cover 14.

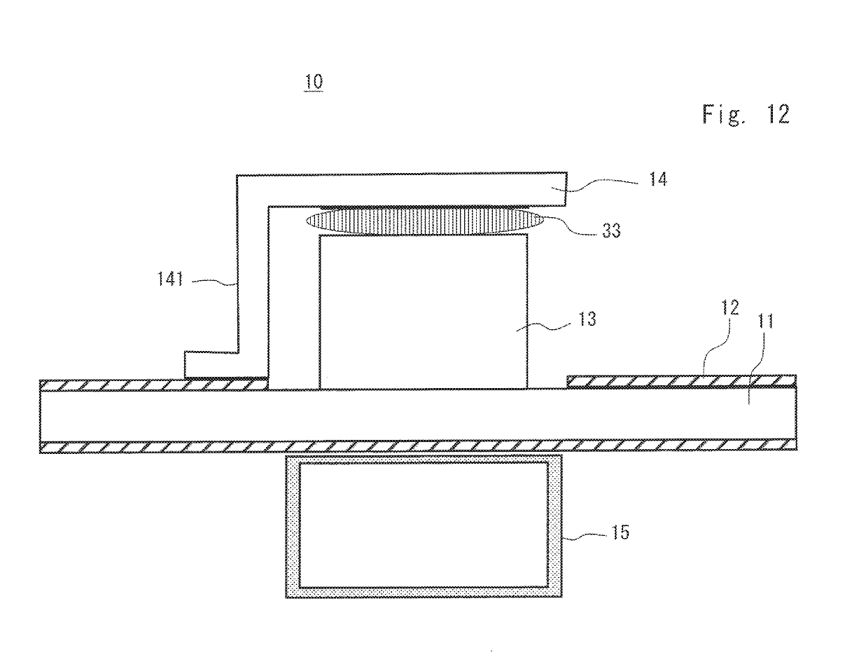

A fourth circulator according to the third exemplary embodiment of the present invention shall be explained. FIG. 12 is a cross-sectional diagram of the fourth circulator 10 according to the third exemplary embodiment. A difference from the structure shown in FIG. 1 is that in the circulator 10 shown in FIG. 12, the ferrite 13 and the metal cover 14 are fixed by a non-conductive adhesive 33. The adhesive 33 fixes the ferrite 13 and the metal cover 14. In this manner, as the gap between the ferrite 13 and the metal cover 14 is fixed, it is possible to reduce characteristic deterioration of the circulator 10 such as deterioration of isolation and reflective characteristics of the circulator 10 that is generated due to the gap.

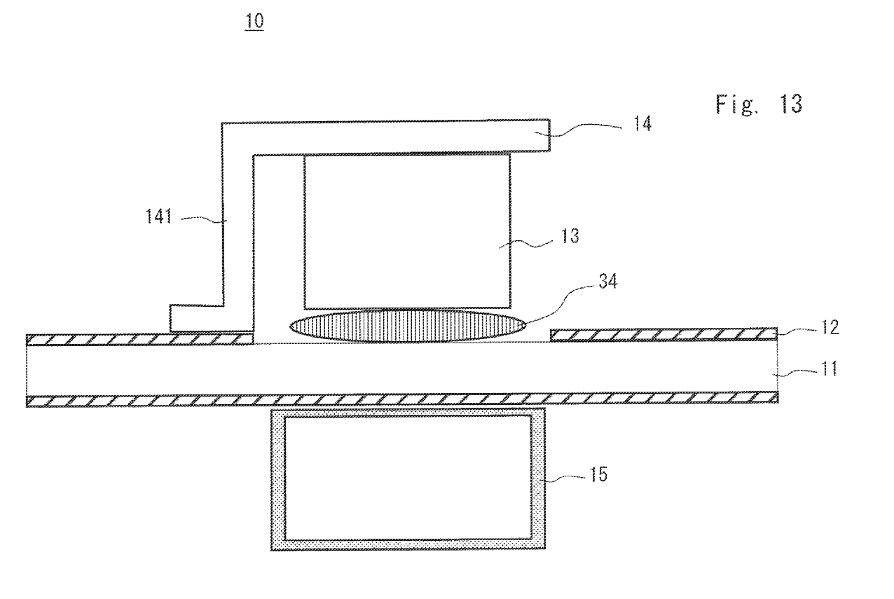

A fifth circulator according to the third exemplary embodiment of the present invention shall be explained. FIG. 13 is a cross-sectional diagram of the fifth circulator 10 according to the third exemplary embodiment. A difference from the structure shown in FIG. 1 is that in the circulator 10 shown in FIG. 13, the ferrite 13 and the PCB 11 are fixed by a non-conductive adhesive 34. In this manner, as the gap between the ferrite 13 and the PCB 11 is fixed, it is possible to reduce characteristic deterioration of the circulator 10 such as deterioration of isolation and reflective characteristics of the circulator 10 that is generated due to the gap.

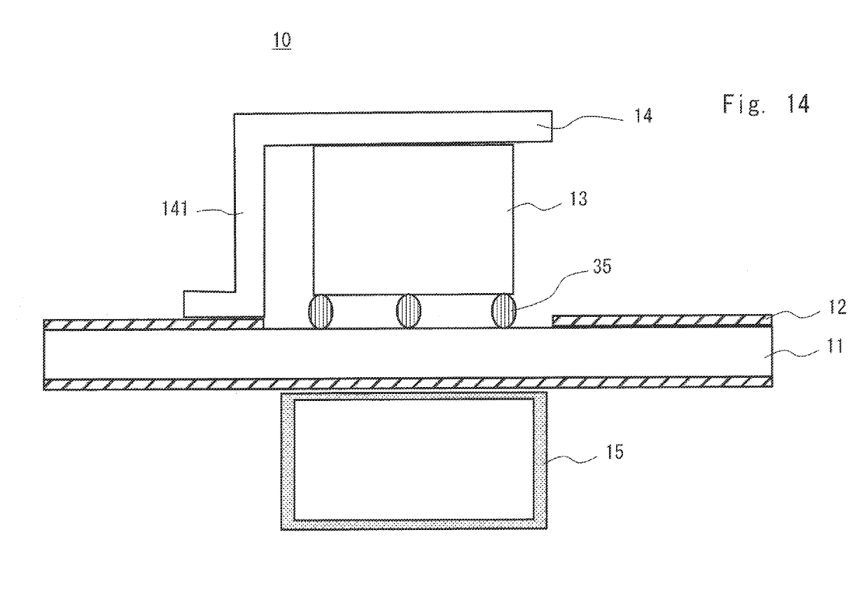

A sixth circulator according to the third exemplary embodiment of the present invention shall be explained. FIG. 14 is a cross-sectional diagram of the sixth circulator 10 according to the third exemplary embodiment. A difference from the structure shown in FIG. 1 is that in the circulator 10 shown in FIG. 14, an outer circumference part and a central part of the ferrite 13 and the PCB 11, respectively, are fixed by a non-conductive adhesive 35. In this manner, as the gap between the ferrite 13 and the PCB 11 is fixed, it is possible to reduce characteristic deterioration of the circulator 10 such as deterioration of isolation and reflective characteristics of the circulator 10 that is generated due to the gap.

Note that fixation between the ferrite 13 and the PCB 11 shown in FIGS. 10 and 11 may be employed together with the fixation between the ferrite 13 and the metal cover 14 shown in FIG. 9. In FIG. 11, the outer circumference part or the central part of the ferrite 13 may be fixed on the upper surface of the PCB 11. The adhesives 25, 27, and 30 may be, for example, silver paste or soldering.

### Fourth Exemplary Embodiment

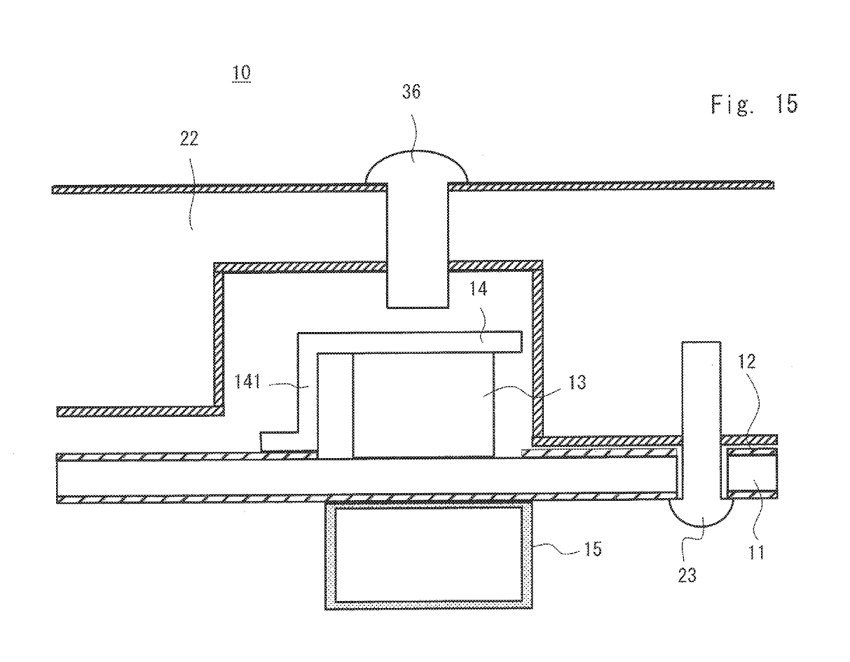

Next, a circulator according to a fourth exemplary embodiment of the present invention shall be explained. FIG. 15 shows a configuration example of a cross-sectional diagram of the circulator 10 according to the fourth exemplary embodiment. A difference from the metal housing 22 shown in FIG. 7 is that in the configuration shown in FIG. 15, a metal screw 36 is buried in a metal wall above the metal cover 14. The metal screw 36 is supported by the metal housing 22, and a screw thread of the metal screw 36 is turned to adjust a distance between the metal screw 36 and the metal cover 14.

The metal screw 36 influences the electric field distribution generated above the metal cover 14. When the metal screw 36 approaches the metal cover 14, an electrical flux line connecting the metal cover 14 and the metal screw 36 is generated in addition to an electrical flux line connecting the metal cover 14 and the metal housing 22. This electrical flux line influences a transmission mode of the high frequency electric field that propagates the metal cover 14. A change in the transmission mode changes characteristic impedance of the metal cover 14. Due to the above-mentioned reason, by changing the distance between the metal screw 36 and the metal cover 14 as appropriate, it is possible to adjust input impedance to the circulator 10.

Note that as long as the distance with the metal cover 14 can be adjusted, a metal part, which is not a screw, may be buried in the metal wall of the metal housing 22 above the metal cover 14. Alternatively, a metal part capable of adjusting the distance with the metal cover 14 may be supported above the metal cover 14 by a supporting part such as a supporting rod and not by the metal housing 22. In this way, it is also possible to change the intensity of the electromagnetic field generated above the metal cover 14 by adjusting the distance between the metal part and the metal cover 14. Thus, it is possible to adjust the input impedance to the circulator 10.

### Fifth Exemplary Embodiment

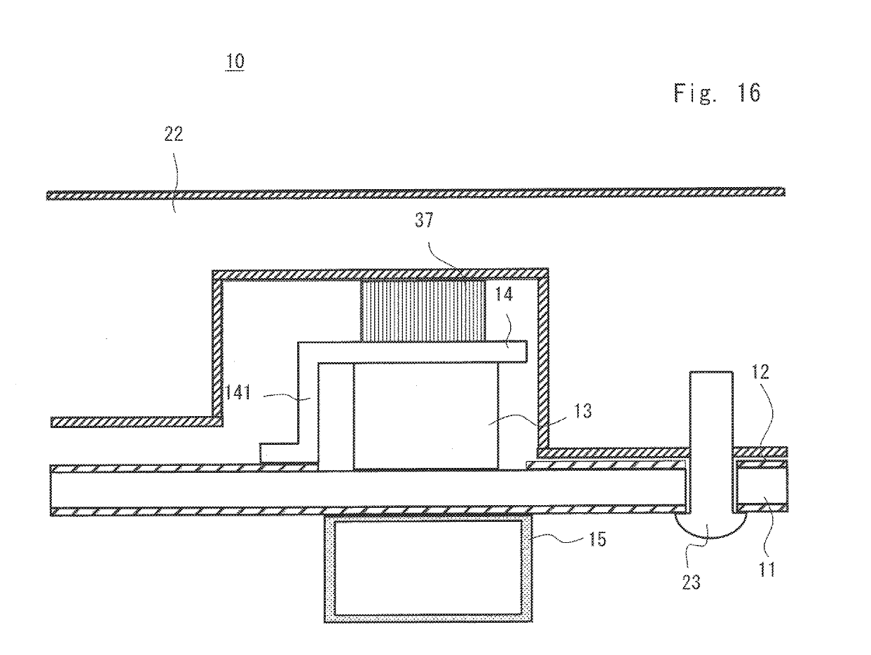

Next, a circulator according to a fifth exemplary embodiment of the present invention shall be explained. FIG. 16 shows a configuration example of a cross-sectional diagram of the circulator 10 according to the fifth exemplary embodiment. A difference from the configuration shown in FIG. 7 is that in the configuration shown in FIG. 16, a dielectric body 37 is sandwiched between the metal cover 14 and the metal wall of the metal housing 22 above the metal cover 14. The pressure applied by the dielectric body 37 on the metal cover 14 presses the metal cover 14 against the ferrite 13 and the ferrite 13 against the PCB 11 and fixes them. In this manner, as the gap between the metal cover 14 and the ferrite 13 and the gap between the ferrite 13 and the PCB 11 can be eliminated, it is possible to reduce characteristic deterioration of the circulator 10 such as deterioration of isolation and reflective characteristics of the circulator 10.

Note that the metal housing 22 is not necessarily required. When the circulator 10 is configured in such a way that a plate formed of metal or a dielectric material is disposed over the dielectric body 37 and the metal cover 14 and the plate presses the dielectric body 37 from above, an exemplary advantage the same as the one explained above can be achieved.

### Sixth Exemplary Embodiment

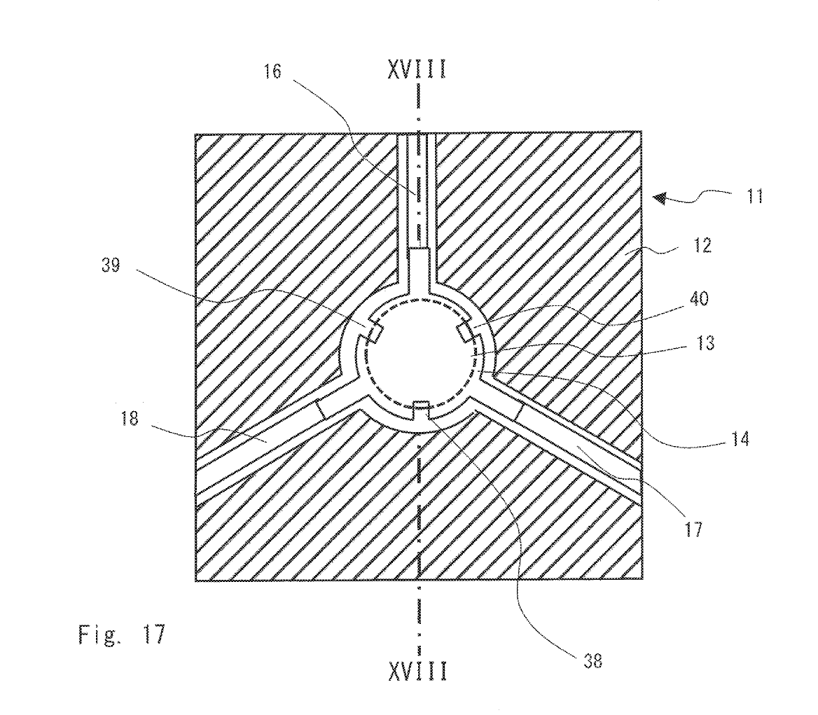

Next, a circulator according to a sixth exemplary embodiment of the present invention shall be explained. FIG. 17 shows a configuration example of a top view of the circulator 10 according to this exemplary embodiment. Three cutout parts 38, 39, and 40 are formed in the metal cover 14. The cutout part 38 is formed at an intersection between an extended line of the transmission line 16 and a circumference (outer edge) of the metal cover 14. The cutout part 39 is formed at an intersection between an extended line of the transmission line 17 and a circumference of the metal cover 14. The cutout part 40 is formed at an intersection between an extended line of the transmission line 18 and a circumference of the metal cover 14. Note that although the cutout parts 38 to 40 have a substantially rectangular shape in FIG. 17, the cutout parts 38 to 40 may have other shapes.

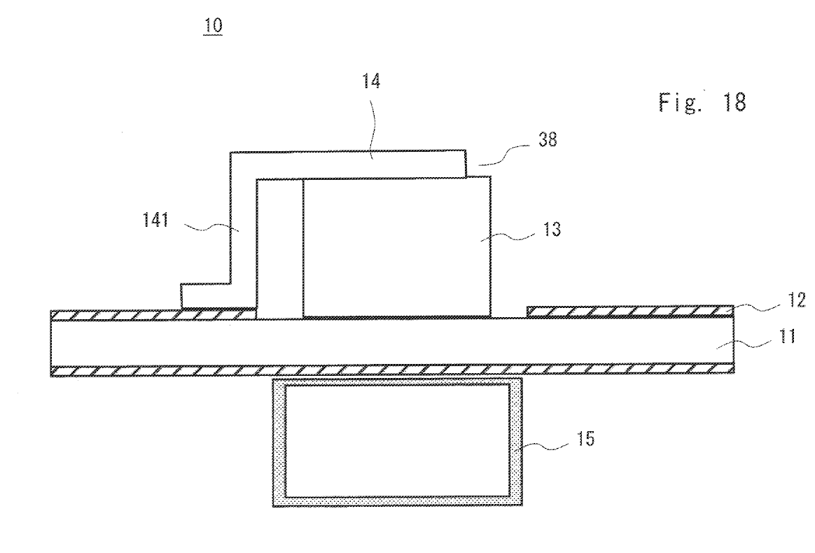

FIG. 18 is a cross-sectional diagram taken along the cross-sectional plane of XVIII of the circulator 10 shown in FIG. 17. FIG. 18 shows a state in which the cutout part 38 is formed in the metal cover 14 that comes into contact with the ferrite 13. A part of the upper surface of the ferrite 13 is exposed by the cutout part 38. Note that the cutout parts 39 and 40 are not shown in FIG. 17. As other parts of the configuration of the circulator 10 shown in FIGS. 17 and 18 are identical to those of the configuration of the circulator 10 shown in FIGS. 1 to 3, an explanation of the other parts of configuration of the circulator 10 in the FIGS. 17 and 18 will be omitted.

As has been explained, it is not necessary for the metal cover 14 to cover the entire upper surface of the ferrite 13. In a degree in which the electromagnetic radiation from the upper surface of the ferrite 13 will not be too large (the radiation loss will not be too large), a part of the upper surface of the ferrite 13 may be exposed by forming a cutout part in the metal cover 14. In this manner, by forming the cutout parts in the metal cover 14 at the intersections of the extended lines of the transmission lines 16 to 18 and the circumference (outer edge) of the metal cover 14, the electromagnetic waves that propagate inside the ferrite 13 can smoothly rotate. In the metal cover 14 having the cutout parts, an RF (Radio Frequency) electric field will not be generated immediately below the cutout. The electric field distribution of the lower surface of the metal cover 14 will be similar to the electric field distribution when a cutout is formed at a T-branch of a waveguide. Then, a frequency fluctuation in the input impedance to the ferrite 13 can be reduced.

Note that the present invention is not limited to the above exemplary embodiments, and modification can be made without departing from the scope of the invention. In other words, various modifications obvious to those skilled in the art can be made to the configurations and details of the present invention within the scope of the present invention. For example, the shape of the metal cover 14 that comes into contact with the ferrite 13 is not necessarily circular, but may be a Y-shape, a triangle or the like. The central angle of the metal cover 14 made by the connection parts 141 and 142 may be an angle other than 120°. This applies to the central angles made by other connection parts.

In the above exemplary embodiment, a circulator has been explained as an example. However, an isolator may be configured by connecting a matched load to one of the three connection parts 141 to 143. Further, the configuration shown in the above exemplary embodiment can be applied to a circulator having four or more transmission lines. In this manner, the circulator explained in the above exemplary embodiments can be applied to a generalized non-reciprocal circuit element.

Such a non-reciprocal circuit element can be included in a transfer circuit (high frequency circuit) that executes transfer of a high frequency signal. Further, such a transfer circuit can be included inside a communication apparatus. For example, when a communication apparatus that executes wireless communication receives the high frequency signal, a circuit that has received the high frequency signal transmits the high frequency signal to the transfer circuit including the non-reciprocal circuit element. Not only the circuit that receives the high frequency signal but the circuit that generates the high frequency signal may function as a transmission circuit that transmits the high frequency signal to the transfer circuit.

The non-reciprocal circuit element transfers the transmitted high frequency signal to a reception circuit that receives the high frequency signal via a predetermined port. By using the above non-reciprocal circuit element, the communication apparatus having such a configuration can be configured.

Note that the circulator described in the first exemplary embodiment can be manufactured as follows. Firstly, the ferrite 13 and the metal cover 14 are disposed above the PCB 11, in which the metal cover 14 covers the upper surfaces of the ferrite 13 and electrically connects the transmission lines 16, 17, and 18 above the pattern 12 to the connection parts 141, 142, and 143, respectively. The permanent magnet 15 is disposed at a position that applies a magnetic field to the ferrite 13. The circulator 10 can be manufactured as explained above. The permanent magnet 15 may be disposed after or before the ferrite 13 and the metal cover 14 are disposed above the PCB 11. The permanent magnet 15 may be disposed at any position as long as the permanent magnet 15 can generate a DC magnetic field in a direction vertical to a high frequency magnetic field inside the ferrite 13 that is generated when a high frequency signal passes through the metal cover 14.

The metal cover 14 may be disposed to cover the upper surface of the ferrite 13 after the ferrite 13 is disposed above the PCB 11. Alternatively, the metal cover 14 may be disposed above the PCB 11 in a state where the ferrite 13 and the metal cover 14 are fixed (e.g. in a state where they are adhered to each other).

The connection parts 141 to 143 may electrically connect between the transmission lines 16 to 18 and the metal cover 14 at the same time when the metal cover 14 is disposed. When the conductive lines 144 to 146 are connected to the metal cover 14 in place of the connection parts 141 to 143, the conductive lines 144 to 146, which are fixed to the outer edge part of the metal cover 14, may be electrically connected to the transmission lines 16 to 18 after the metal cover 14 is disposed.

The circulators described in other exemplary embodiments can be manufactured in a manner similar to that of the circulator above. The above-mentioned isolator and the circulators including four or more transmission lines can be manufactured in a similar manner to those explained above.

The present application claims priority rights of and is based on Japanese Patent Application No. 2011-274626 filed on Dec. 15, 2011 in the Japanese Patent Office, the entire contents of which are hereby incorporated by reference.

### INDUSTRIAL APPLICABILITY

The technique according to the present invention can be used for a non-reciprocal circuit element, a communication apparatus equipped with a circuit including the non-reciprocal circuit element, and a non-reciprocal circuit element.

### REFERENCE SIGNS LIST

10 CIRCULATOR
11 PCB
12 PATTERN
13 FERRITE
14 METAL COVER
141, 142, 143 CONNECTION PART
144, 145, 146 CONDUCTIVE LINE
15 PERMANENT MAGNET
16, 17, 18 TRANSMISSION LINE
19, 20, 21 POWER SUPPLY POINT
22, 24 METAL HOUSING
23 SCREW
25, 27, 30 CONDUCTIVE ADHESIVE
26, 28, 29, 31, 32 CONDUCTIVE MEMBER
33, 34, 35 NON-CONDUCTIVE ADHESIVE
36 METAL SCREW
37 DIELECTRIC BODY
38, 39, 40 CUTOUT PART

1. A non-reciprocal circuit element comprising:
a ferrimagnet that is disposed above a circuit board;
a conductive cover that covers an upper surface of the ferrimagnet and is formed integrally;
a plurality of connection parts that electrically connect the conductive cover to a plurality of respective signal transmission lines above the circuit board; and
a magnet that applies a magnetic field to the ferrimagnet.

2. The non-reciprocal circuit element according to claim 1, wherein the conductive cover and the connection parts are formed integrally.

3. The non-reciprocal circuit element according to claim 1, wherein
the ferrimagnet is disposed above a first plane of the circuit board, and
the magnet is disposed above a side of a second plane of the circuit board that is opposite to the first plane.

4. The non-reciprocal circuit element according to claim 3, wherein
the magnet is disposed at a position opposite to the ferrimagnet with the circuit board interposed therebetween.

5. The non-reciprocal circuit element according to claim 1, wherein a cutout is formed at an intersection between extended lines of the plurality of signal transmission lines and an outer edge of the conductive cover.

6. The non-reciprocal circuit element according to claim 1, further comprising:
a metal part that is disposed above the conductive cover and is capable of adjusting a distance with the conductive cover; and
a support part that supports the metal part.

7. The non-reciprocal circuit element according to claim 1, further comprising:
a metal plate that covers above the conductive cover; and
a dielectric body that is sandwiched between the conductive cover and the metal plate.

8. The non-reciprocal circuit element according to claim 1, wherein
the ferrimagnet is fixed to at least one of the conductive cover and the circuit board.

9. A communication apparatus comprising:
a transmission circuit that transmits a high frequency signal;
a transfer circuit that includes the non-reciprocal circuit element according to claim 1 and transfers the high frequency signal from the transmission circuit; and
a reception circuit that receives the high frequency signal from the transfer circuit.

10. A method of manufacturing a non-reciprocal circuit element, the method comprising:
disposing a ferrimagnet and a conductive cover above a circuit board, the conductive cover covering an upper surface of the ferrimagnet, being electrically connected each of a plurality of signal transmission lines above the circuit board, and being integrally formed; and
disposing a magnet at a position to enable a magnetic field to be applied to the ferrimagnet.
